(19) United States
(12) Patent Application Publication
(10) Pub. No.: US 2024/0373123 A1
(43) Pub. Date: Nov. 7, 2024

(54) IMAGE PROCESSING APPARATUS AND IMAGE PROCESSING METHOD

(71) Applicant: CANON KABUSHIKI KAISHA, Tokyo (JP)

(72) Inventor: NARUMI MATSUOKA, Kanagawa (JP)

(21) Appl. No.: 18/644,469

(22) Filed: Apr. 24, 2024

(30) Foreign Application Priority Data
May 1, 2023 (JP) 2023-075813

(51) Int. Cl. H04N 23/63; H04N 23/80; H04N 23/81

(52) U.S. Cl. CPC H04N 23/632; H04N 23/81; H04N 23/815

(57) ABSTRACT

An image processing apparatus that generates display image data for live view display on a display device, the image processing apparatus comprising: one or more processors that execute a program stored in a memory and thereby function as: an obtaining unit configured to obtain information indicating a current maximum display brightness of the display device; a determining unit configured to determine a parameter for correcting at least one of noise and resolution of image data based on the information; and a generating unit configured to generate display image data for live view display on the display device by correcting obtained image data according to the parameter.

### BACKGROUND OF THE INVENTION

### Field of the Invention

The present invention relates to an image processing apparatus and an image processing method for displaying a captured video as a live view.

### Description of the Related Art

Cameras equipped with a so-called live view display function of displaying a video in real time in a display device such as an electronic viewfinder when performing shooting are becoming widespread. In Japanese Patent Laid-Open No. 2018-186363 (hereinafter, PL1), a technique is disclosed for performing a live view display in which a noise amount is small even when shooting is performed with a high ISO sensitivity in a night scene or the like.

In PL1, in order to reduce color noise in an image to be displayed, color components of the color noise are estimated by comparing display colors between captured data obtained by capturing at a low ISO sensitivity and captured data obtained by capturing at a high ISO sensitivity, and color correction is performed according to the estimation result.

However, with the technique disclosed in PL1, a problem in that perceptual noise in a live view image changes according to the display brightness of a display device cannot be resolved. This problem may also arise when the display brightness of a display device is automatically changed according to surrounding brightness, or when a user can change the display brightness.

In addition, although a similar problem can occur for a live view image, not only in terms of perceptual noise but also in terms of perceptual resolution, PL1 is silent about such a problem.

### SUMMARY OF THE INVENTION

The present invention has been made in view of the problem of a known technique described above, and provides, in one aspect thereof, an image processing apparatus and an image processing method with which the change, in perceptual noise and perceptual resolution in a live view image, that is incurred by image capture sensitivity and maximum display brightness can be suppressed.

According to an aspect of the present invention, there is provided an image processing apparatus that generates display image data for live view display on a display device, the image processing apparatus comprising: one or more processors that execute a program stored in a memory and thereby function as: an obtaining unit configured to obtain information indicating a current maximum display brightness of the display device; a determining unit configured to determine a parameter for correcting at least one of noise and resolution of image data based on the information; and a generating unit configured to generate display image data for live view display on the display device by correcting obtained image data according to the parameter.

According to another aspect of the present invention, there is provided an image processing method for generating display image data for live view display on a display device, the image processing method comprising: obtaining information indicating current maximum display brightness of the display device; determining a parameter for correcting at least one of noise and resolution of image data based on the information; and generating display image data for live view display on the display device by correcting obtained image data according to the parameter.

According to further aspect of the present invention, there is provided a non-transitory computer-readable medium storing a program that, when executed by a computer, causes the computer to perform an image processing method for generating display image data for live view display on a display device, the image processing method comprising: obtaining information indicating current maximum display brightness of the display device; determining a parameter for correcting at least one of noise and resolution of image data based on the information; and generating display image data for live view display on the display device by correcting obtained image data according to the parameter.

Further features of the present invention will become apparent from the following description of exemplary embodiments (with reference to the attached drawings).

### BRIEF DESCRIPTION OF THE DRAWINGS

FIG. 1 shows a functional block diagram of a digital camera as an example of an image processing apparatus according to an embodiment.

FIG. 2 is a diagram illustrating comparison conditions according to the embodiment and modifications.

FIGS. 3A and 3B are diagrams illustrating an image to be displayed in a display device according to the embodiment and the modifications.

FIG. 4 is a diagram illustrating a luminance value of a display image according to the embodiment and the modifications.

FIG. 5 is a diagram illustrating a perceived amount of a luminance value of a display image according to the embodiment and the modifications.

FIG. 6 is a diagram illustrating a perceived amount of an overshoot and an undershoot of a display image according to the embodiment and the modifications.

FIG. 7 is a block diagram illustrating an exemplary functional configuration of an image processing unit according to the embodiment and the modifications.

FIG. 8 is a flowchart illustrating processing contents of a control unit according to the embodiment.

### DESCRIPTION OF THE EMBODIMENTS

Hereinafter, embodiments will be described in detail with reference to the attached drawings. Note, the following embodiments are not intended to limit the scope of the claimed invention. Multiple features are described in the embodiments, but limitation is not made to an invention that requires all such features, and multiple such features may be combined as appropriate. Furthermore, in the attached drawings, the same reference numerals are given to the same or similar configurations, and redundant description thereof is omitted.

### First Embodiment

Hereinafter, an embodiment will be described in which the present invention is applied to a digital camera 100 including a display device that can operate as an electronic viewfinder, serving as an example of an image processing apparatus. However, the present invention can be implemented in an electronic device that can generate a display image. For example, the electronic devices that can implement the present invention includes digital video cameras, personal computers, tablet terminals, mobile phones, game machines, transmissive goggles used for augmented reality (AR) and mixed reality (MR) presentations, and the like, but there is no limitation to these.

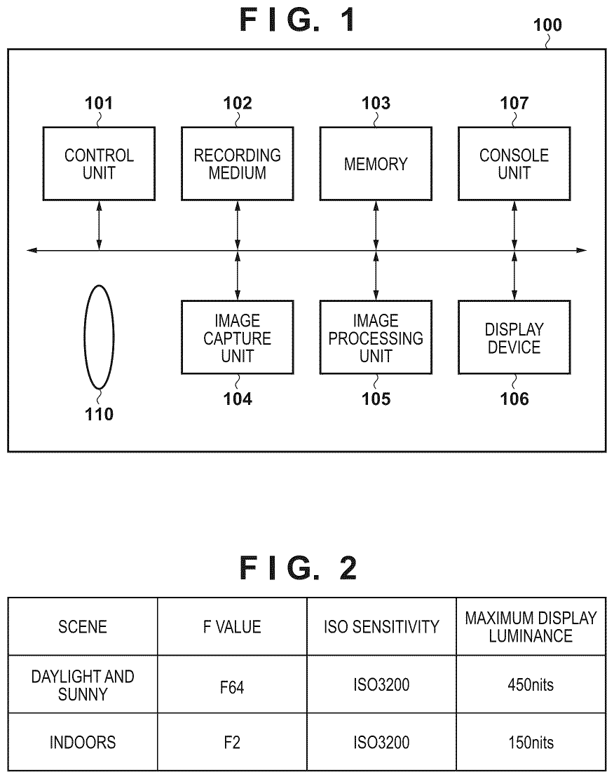

The configuration of a digital camera 100 is shown in FIG. 1. The digital camera 100 includes a control unit 101, a recording medium 102, a memory 103, an image capture unit 104, an image processing unit 105, a display device 106, a console unit 107, and a lens 110, and these blocks are communicably connected by a system bus.

The control unit 101 is a control unit constituted by at least one processor or circuit. The control unit 101 reads out an operation program from the recording medium 102, deploys and executes the operation program in the memory 103, and with this, controls the blocks and realizes the functions of the digital camera.

The recording medium 102 is a nonvolatile recording device that is configured to be electrically erasable/recordable, such as a Flash-ROM, for example. The recording medium 102 also stores information such as constants and parameters needed for operations of blocks included in the digital camera 100, in addition to operation programs of the blocks. Also, the recording medium 102 may also be a constituent element (semiconductor memory card) for recording images (RAW data, developed images, and the like) obtained by capturing. Meanwhile, the memory 103 is a volatile recording device such as an SRAM or a DRAM, and is used as a deployment area and a work area of the operation programs of the blocks. Also, the memory 103 is used as a VRAM when displaying an image in a later-described display device 106.

The lens 110 is a unit in which an image capture lens group is mounted, and is configured to be attachable to and detachable from the digital camera 100. Note that, in general, the lens 110 is configured by a plurality of lenses, but only one lens is shown in FIG. 1, for simplification. The lens 110 includes an unshown control circuit. The control circuit controls movements of a focus lens and the like based on a driving signal input from the control unit 101, for example.

The image capture unit 104 is an image sensor such as a CCD or CMOS sensor, for example, and obtains an analog image signal by converting an optical image formed on an imaging surface by the lens 110 to an electrical signal. The obtained analog image signal is converted to a digital image signal (hereinafter, referred to as RAW data) by an unshown A/D converter. In the present embodiment, description will be given assuming that the image capture unit 104 is a single plate color image sensor including an ordinary primary color filter. Here, the primary color filter is constituted by three types of color filters that are arranged in a mosaic pattern (Bayer array), the color filters respectively having primary transmission wave length zones in the vicinity of 650 nm, 550 nm, and 450 nm. By applying the primary color filter, each pixel of the single plate color image sensor captures a color plane corresponding to one of red (R), green (G), and blue (B) bands. In other words, each of photoelectric conversion elements that constitute the single plate color image sensor can only obtain a light intensity regarding a single color plane. Also, the image capture unit 104 may include peripheral circuits such as an amplification circuit that process signals obtained from the pixels.

The image processing unit 105 performs various types of image processing such as pixel interpolation, resizing, and color conversion on RAW data from the image capture unit 104 or RAW data read out from the recording medium 102 (to be described in detail later). Also, the image processing unit 105 derives information needed for exposure control and distance measuring control by performing computation processing on RAW data obtained by capturing. The digital camera 100 of the present embodiment performs through the lens (TTL) type autofocus (AF) processing, automatic exposure (AE) processing, and flash pre-emission (EF) processing based on the derived information. Also, the image processing unit 105 performs TTL-type automatic white balance (AWB) processing by performing computation on image data obtained by capturing.

The display device 106 is a display device such as a liquid crystal display, for example, and displays information such as setting values of the digital camera 100, a GUI such as message and menu screens, captured images, or the like. The display device 106 may be an electronic viewfinder (EVF) or a rear liquid crystal display that is incorporated in the digital camera 100, or an external display detachably connected to the digital camera 100. In the following description, display control of an electronic viewfinder in a period in which the digital camera 100 is performing image capture will be described, and therefore description will be given assuming that the display device 106 functions as an electronic viewfinder. An image to be displayed in order to cause the display device 106 to function as an electronic viewfinder is referred to as a live view image.

Also, the display device 106 includes an unshown display control circuit, and is configured to be able to change its maximum display brightness. When the display device 106 is a liquid crystal display, the maximum display brightness depends on the backlight brightness. Also, the maximum display brightness of the display device 106 is dynamically controlled according to a Bv value (luminance value) obtained by a result of photometry performed in an image capture scene, for example. Alternatively, the maximum display brightness may also be controlled based on a brightness of a scene that is estimated according to a set image capture mode. That is, the maximum display brightness in the present embodiment does not indicate the brightest brightness that a display device can display (display capability), and instead indicates a maximum display brightness under the current display control. Here, the photometry of the image capture scene may be performed based on an image signal obtained by capturing, or may also be performed based on an output of a photometry sensor provided separately or the like. In the present embodiment, a configuration may be adopted in which information regarding the maximum display brightness of the display device 106 can be obtained, and the information is supplied at least to the image processing unit 105.

The console unit 107 is user interfaces included in the digital camera 100 of the present embodiment for receiving various types of input operations. Upon detecting that an input operation is performed on a user interface, the console unit 107 outputs a corresponding control signal to the control unit 101. The console unit 107 includes a release switch for instructing to start a shooting preparation operation and instructing to start shooting (actual shooting), an image capture mode selection switch for selecting the image capture mode, a direction key, a determination key, and the like. Also, the console unit may also include a touch panel.

In the present embodiment, description will be given assuming that the processing according to the invention is realized by circuits respectively corresponding to the blocks and a processor that are included in the digital camera 100, as pieces of hardware. However, the implementation of the present invention is not limited to this, and the processing of each block may also be realized by a program for performing processing similar to that of the block.

### <Live View Image Generation Control>

Next, generation of a live view image (display image) for allowing the display device 106 to function as an electronic viewfinder, which is performed in the digital camera 100 of the present embodiment, will be described in detail. The digital camera 100 of the present embodiment sequentially displays captured images obtained by the image capture unit 104 (at an image capture frame rate of 30 frames per second, for example) in the display device 106.

The digital camera 100 of the present embodiment is configured to be able to preset contrast correction, exposure correction, chroma correction, and the like that are performed in the course of development processing, in at least some of image capture modes for recording a developed image.

The generation of a display image by the image processing unit 105 at least includes tone conversion in which a tone value is assigned to a signal intensity indicated in RAW data. The tone conversion is performed based on input/output characteristics that indicate the relationship between signal values of RAW data and tone values after development processing. For example, when one component of RAW data is represented by 14 bits, and one component after development processing is represented by 8 bits, the conversion from a 14-bit tone value to an 8-bit tone value corresponds to this tone conversion.

Also, considering the visibility of a live view image, the maximum display brightness of the display device 106 is controlled so as to be changed depending on whether the image capture scene is bright or dark (in an extreme case, whether the scene is in daylight and sunny or indoors). Specifically, when the image capture scene is a bright scene such as being in daylight and sunny, the maximum display brightness is set to 450 nits, and when the image capture scene is a relatively dark scene such as being indoors, the maximum display brightness is set to 150 nits. However, the values of the maximum display brightness in the respective scenes are not limited to these, and other valued may also be set. Note that whether the image capture scene is in daylight and sunny or indoors is selected by a user through the console unit 107, but the scene may also be automatically selected using a sensor for detecting the brightness.

Here, the difference in visual perception of human when the maximum display brightness differs will be described.

According to the Weber-Fechner law, the sensory amount perceived by human is in proportion to a logarithm of a stimulus amount given to a sensory receptor. In this specification, based on such a relationship between the sensory amount and the stimulus amount, the differences in the perceptual resolution and the perceptual noise in a displayed image through the electronic viewfinder by perceptual resolutionperceptual noiseperceptual resolutionperceptual noiseevaluating the final display brightness, in which the maximum display brightness of the display device 106 is considered, as a sensory amount.

Luminance component values in a perceptually uniform color space conforming to human visual characteristics are used below for illustrating the relationship between the perceptual resolution and perceptual noise of a display image and the absolute luminance. In the present embodiment, the I value in the ICtCp color space defined in ITU-R BT.2100 is adopted as the luminance component value in the perceptually uniform color space, and the Ct value and Cp value are adopted as the color component values. The I value can be derived from RGB values using inverse characteristics (Inverse EOTF) of an electro-optical transfer function (EOTF) of a perceptual quantization (PQ) method, which is standardized in SMPTE ST 2084. The PQ method defines an absolute luminance that does not depend on a display characteristic unique to a display device, the bit allocation is efficiently performed based on the human visual characteristics, and therefore it is preferable for defining the sensory amount.

An example of a comparison condition in the present embodiment is shown in FIG. 2. A case is considered in which the lens aperture value is f/64 and the image capture sensitivity is ISO 3200, when performing image capture of a daylight and sunny scene. Here, the scene is bright, and therefore the maximum display brightness of the electronic viewfinder (display device 106) is 450 nits. In contrast, a case is considered in which the lens aperture value is f/2 and the image capture sensitivity is ISO 3200, when performing image capture of an indoor scene. Here, the scene is dark, and therefore the maximum display brightness of the electronic viewfinder is 150 nits.

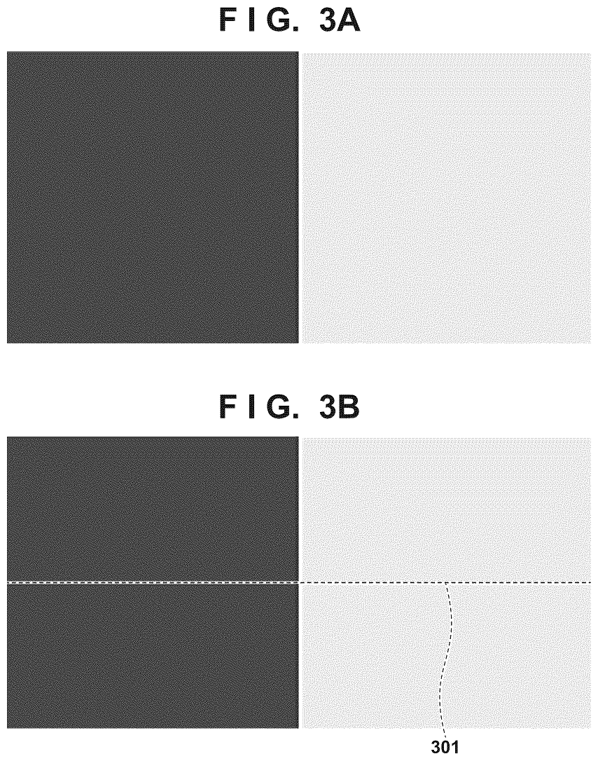

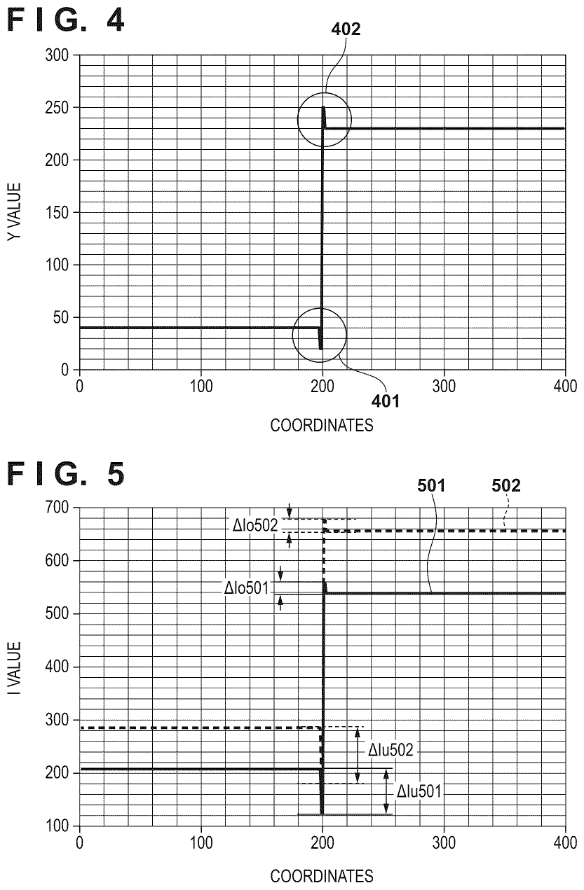

Here, a case is considered in which a high contrast subject, as shown in FIG. 3A is displayed in the electronic viewfinder. In general, noise is generated when performing image capture at a high ISO sensitivity. Also, it is known that the strength of perceptual resolution correction processing such as sharpness processing is adjusted according to the ISO sensitivity in order to suppress increase in noise due to image capture sensitivity. FIG. 4 shows a line profile of the luminance value Y in an area indicated by a broken line 301 in FIG. 3B when perceptual resolution correction processing is performed at a strength according only to the ISO sensitivity. A depression indicated by a reference numeral 401 is referred to as an undershoot, and a bulge as indicated by a reference numeral 402 is referred to as an overshoot, which occur when perceptual resolution correction processing such as sharpness processing is performed. In general, the larger the width of the undershoot and overshoot is, the higher perceptual resolution can be perceived.

### <Adjustment of Perceptual Resolution>

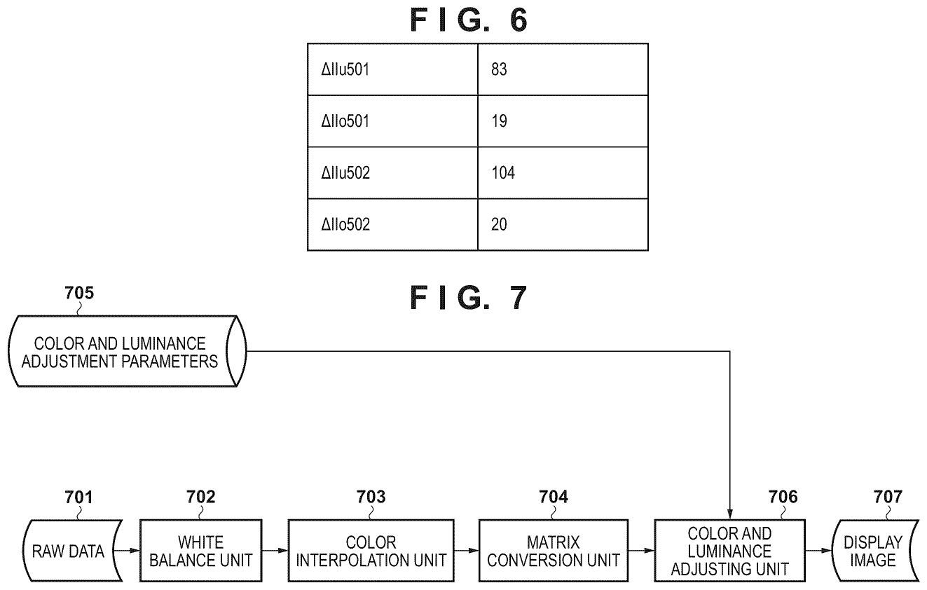

When perceptual resolution correction processing according only to the ISO sensitivity at the time of image capture is performed, even if the image capture ISO sensitivity is the same, the perceived amount of perceptual resolution changes depending of the maximum display brightness of a display device. By using the aforementioned I value in the ICtCp color space, the perceived amount conforming to visual characteristics is evaluated. FIG. 5 shows a perceived amount of perceptual resolution obtained by converting the line profile in FIG. 4 by performing conversion to I values, when the maximum display brightness of the display device is set to 150 nits or 450 nits. A reference numeral 501 indicates an I value when the maximum display brightness is 150 nits, and a reference numeral 502 indicates an I value when the maximum display brightness is 450 nits. The overshoot when the maximum display brightness is 150 nits is denoted as ΔIo501, and the undershoot when the maximum display brightness is 150 nits is denoted as ΔIu501. Also, the overshoot when the maximum display brightness is 450 nits is denoted as ΔIo502, and the undershoot when the maximum display brightness is 450 nits is denoted as ΔIu502. These values are shown in FIG. 6.

As shown in FIG. 6, ΔIo502 is larger than ΔIo501, and similarly ΔIu502 is larger than ΔIu501. Therefore, the perceptual resolution perceived when the maximum display brightness is 450 nits is higher than that when the maximum display brightness is 150 nits. If the perceptual resolution perceived on images captured at the same ISO sensitivity differs depending on the viewing environment, that is, the maximum display brightness of the electronic viewfinder, as described above, it may feel unnatural to a user. Therefore, the sharpness processing when performing display at 450 nits is weakened such that ΔIo501 equals to ΔIo502, and ΔIu501 equals to ΔIu502, with 150 nits being the reference, and as a result, the influence of the difference in maximum display brightness of the display device 106 on the perceptual resolution perceived from a live view image is suppressed, and display can be performed in which the perceptual resolution can be uniformly perceived.

Note that the sharpness processing when performing display at 150 nits may also be strengthened, with 450 nits being the reference, and the strengths of sharpness processing for 450 nits and 150 nits may also be respectively adjusted, with a luminance different from these being the reference. That is, by adjusting the sharpness processing (selecting a sharpness filter to be used) according to the maximum display brightness of a display device, in addition to the image capture ISO sensitivity, display can be realized in which the perceptual resolution perceived according to the scene brightness is uniform.

Also, sharpness processing has been taken as an example of perceptual resolution adjustment processing, but any perceptual resolution correction processing such as diffraction correction processing, or a combination of these may also be adopted.

### <Adjustment of Perceptual Noise>

Similarly to the perceptual resolution, the noise amount is calculated using ICtCp values in order to calculate a perceived amount of noise. By using an I value for luminance noise, and using a Ct value and a Cp value for color noise, a noise amount according to perception characteristics can be calculated. Similarly to the perceptual resolution, if noise reduction processing of the same strength is performed when the maximum display brightness is 150 nits and when the maximum display brightness is 450 nits, it is easily envisioned that more perceptual noise is perceived in the case of 450 nits and it is possible that a user feels uncomfortable. Here, by strengthening the noise reduction processing when display is performed at the maximum display brightness of 450 nits such that the perceived amounts of luminance noise and color noise are respectively the same as perceived amounts when display is performed at the maximum display brightness of 150 nits, with the characteristics at the maximum display brightness of 150 nits being the reference, the change given by the difference in maximum display brightness on perceptual resolution perceived on a live view image can be suppressed, and display can be performed in which the perceptual noise is uniform.

The reference luminance may be one of 150 nits and 450 nits, similarly to the adjustment of the perceptual resolution, or may also be luminance different from these. Also, it is assumed that a plurality of noise reduction filters to be used in the noise reduction processing are prepared in advance, and noise reduction processing is performed by selecting one of these filters as appropriate.

### <Adjustment of Threshold Value in Peaking Processing>

Peaking processing is widely known as one of auxiliary functions of focus adjustment in manual focus or the like. The peaking processing is a function in which edge portions in a display image are determined using a predetermined threshold value, and the obtained edge portion areas are colored in a predetermined color, and with this an in-focus area can be easily recognized. It is possible that, as a result of adjusting the sharpness strength according to the maximum display brightness, if coloring at the time of peaking processing, that is, the determination results regarding an edge portion changes, usability degrades.

By maintaining the coloring result at the time of peaking processing by changing the threshold value according to the adjustment amount of the sharpness strength, degradation of usability can be prevented.

### <Functional Configuration of Image Processing Unit 105>

Next, the functional configuration and operations of the image processing unit 105 regarding generation of a display image will be described with reference to FIG. 7. FIG. 7 shows a configuration of the image processing unit 105 regarding development processing for a display image.

It is assumed that, in the image capture unit 104, three types of color filters, namely R, G, and B color filters are arranged in a mosaic pattern on an imaging surface of the image sensor (typically, in Bayer array). Therefore, RAW data 701 can be said as color mosaic image data in which one pixel is represented by one component (any one of R, G, and B). The image processing unit 105 reads out RAW data 701 from the memory 103, and generates a display image 707 in which one pixel is constituted by three components by applying development processing on the RAW data 701.

First, the white balance unit 702 performs, on the RAW data 701, white balance processing in which color conversion is performed such that the color of an image of a subject that is originally white is white. Specifically, the white balance unit 702 plots RGB data of each pixel that constitutes the RAW data 701 in a predetermined color space such as an xy color space, for example. Also, the white balance unit 702 integrates R, G, and B values of data that is plotted in the vicinity of a black body radiation locus that is highly possibly a light source color in the color space, and derives white balance coefficients (G/R and G/B) of the R and B components from the integrated value. The white balance unit 702 reproduces white by correcting color fogging due to light source by performing white balance processing using the obtained white balance coefficients.

The color interpolation unit 703 performs, on image data obtained by conversion performed by the white balance unit 702, noise reduction processing and processing for interpolating pixel values of color components that are not included in each pixel. As a result of performing the processing, a synchronized image is generated in which, with respect to all pixels, pieces of color information of R, G, and B (pixel values of color components) are complete.

The matrix conversion unit 704 converts a synchronized image generated by the color interpolation unit 703 to a color image, which is a base for processing, by performing matrix conversion processing. Moreover, the color and luminance adjusting unit 706 generates a display image 707, which is for live viewing, by applying, on this color image, adjustment processing in which color and luminance are adjusted.

Here, the adjustment performed by the color and luminance adjusting unit 706 includes an adjustment performed with reference to color and luminance adjustment parameters 705 in which settings regarding contrast correction, exposure correction, chroma correction, sharpness correction, and the like that are applied to a recording image are described according to the current maximum display brightness of the display device 106 (information indicating the driving condition of a backlight, because a liquid crystal display is adopted in the embodiment).

The display image 707 generated as described above is displayed in the display device 106 in which the maximum display brightness is controlled according to an image capture scene, and as a result, the electronic viewfinder is realized.

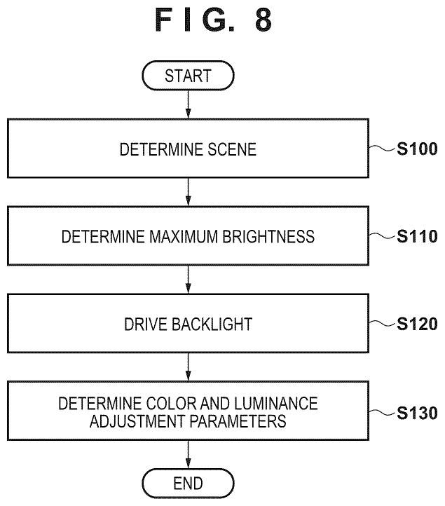

Next, the processing, by the control unit 101 in the embodiment, until the color and luminance adjustment parameters 705 are obtained will be described with reference to the flowchart in FIG. 8. The program related to the drawing is loaded from the recording medium 102 to the memory 103 and is executed. Also, it is assumed that this program is not executed every frame of capturing by the image capture unit 104 and is executed at a suitable frame interval (e.g., at an interval of several seconds).

In step S100, the control unit 101 causes the image capture unit 104 to obtain current RAW data, and determines the scene currently under shooting. As a specific example, the control unit 101 obtains a Bv value from a shooting condition of the RAW data. Then, the control unit 101 compares the Bv value with a threshold value Th that is retained in advance. Upon determining that the Bv value is the threshold value Th or more, the control unit 101 determines that the shooting is performed under daylight and sunny. Also, upon determining that the Bv value is less than the threshold value Th, the control unit 101 determines that the shooting is performed indoors.

In step S110, the control unit 101 determines the maximum display brightness of the display device 106. Upon determining that the shooting is currently performed under daylight and sunny, the control unit 101 of the embodiment described above determines 450 nits as the maximum display brightness of the display device 106. On the other hand, upon determining that the shooting is currently performed indoors, the control unit 101 determines 150 nits as the maximum display brightness of the display device 106.

Then, in step S120, the control unit 101 drives the backlight of the display device 106 such that the determined maximum display brightness is realized. This driving state of the backlight is maintained until this processing is performed next time.

In step S130, the control unit 101 determines the color and luminance adjustment parameters 705 in order to perform display illustrated previously according to the determined maximum display brightness.

According to the present embodiment as described above, a display image can be generated with which uniform perceptual resolution and perceptual noise are caused to be perceived, regardless of the maximum display brightness of a display device.

Note that, in the embodiment described above, the display device 106 has been described taking a liquid crystal display using a backlight as an example. However, the type of the display device is not limited to this, and the disclosed technique may also be applied to a light emitting organic EL device, for example. In this case, because the device itself emits light, the maximum display brightness can be set by adjusting the driving signal of the device.

Also, in the embodiment described above, description has been given in which the maximum display brightness that can be displayed by the display device 106 is 450 nits and 150 nits, but the values of the maximum display brightness are not limited to these. Also, the types of the changeable maximum display brightness of the display device 106 are not limited to two levels, and may also be three or more multiple levels.

Also, in the embodiment described above, the scene is determined from image data obtained by capturing, but a configuration may also be adopted in which a user selects the type of the scene by operating the console unit 107. That is, the maximum display brightness of the display device 106 may also be switched by a user operation.

Also, in the embodiment described above, perceptual resolution adjustment processing according to the settings of the ISO sensitivity and maximum display brightness has been applied to live view image data. On the other hand, perceptual resolution adjustment processing according to only the ISO sensitivity may also be applied to image data for recording.

Also, in the embodiment described above, in the perceptual resolution adjustment processing, when display is performed at second display brightness that is brighter than the first display brightness, with reference to the first display brightness of the display device, the noise reduction processing is strengthened or the perceptual resolution correction processing is weakened such that the difference in perceived amount is reduced. Moreover, when display is performed at third display brightness that is less bright than the first display brightness, the noise reduction processing may be weakened or the perceptual resolution correction processing may be strengthened such that the difference in perceived amount is reduced.

Also, in the embodiment described above, the image processing unit 105 has been described as having a configuration shown in FIG. 7. However, when the processing capability of the control unit 101 is sufficiently high, each constituent element shown in FIG. 7 may also be realized by the control unit 101 executing a program.

Also, in the embodiment described above, description has been given regarding generation of image data for live view display, and regarding image data to be recorded in a recording medium, processing that is irrelevant to the maximum display brightness of a display device may also be performed on the image data. For example, processing according to the exposure such as the ISO sensitivity, in addition to the maximum display brightness of a display device, has been performed on image data for live view display. Only processing according to the ISO sensitivity and the like may be performed on image data for recording without considering the maximum display brightness.

### [Modification 1]

The present embodiment can be implemented in a device that generates, for a display device that can change the maximum display brightness, an image that presents perceptual resolution and perceptual noise that are uniformly perceived irrespective to the change. Here, the information regarding the set maximum display brightness may be able to be obtained from the display device via a signal defined in a standard adopted for the connection with the display device 106, or may also be able to be obtained from another device that controls operations of the display device. That is, the maximum display brightness need not be determined based on a photometry result of the image capture scene, as in the first embodiment.

### [Modification 2]

The present embodiment may also be applied at the time of generating a display image for an external display that is detachably connected to the digital camera 100. The perceptual resolution and perceptual noise may also be adjusted according to information regarding the maximum display brightness that is obtained from the external display. Also, whether or not adjustment is performed according to the maximum display brightness information can be switched by a user instruction or the like, when display is performed in an external display.

### [Modification 3]

The present embodiment may also be applied to a case where a display image is displayed in an external display and an electronic viewfinder or a rear liquid crystal display that is incorporated in the digital camera 100 at the same time. That is, the perceptual resolution and perceptual noise may be adjusted according to the maximum display brightness, in each of the external display and the electronic viewfinder or rear liquid crystal display, or may also be adjusted according to the maximum display brightness of only one of the devices.

### [Modification 4]

In the present embodiment, an image is generated, for a display device that can change the maximum display brightness, that presents perceptual resolution and perceptual noise that are uniformly perceived irrespective to the change. The present invention aims to reduce uncomfortable feeling at the time of shooting, and therefore needs only be applied to a display image, and need not be applied to a recording image. That is, a configuration may also be adopted in which the perceptual resolution and perceptual noise for a recording image is adjusted according only to the image capture ISO sensitivity.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-75813 filed on May 1, 2023 which is hereby incorporated by reference herein in its entirety.

What is claimed is:

1. An image processing apparatus that generates display image data for live view display on a display device, the image processing apparatus comprising:
one or more processors that execute a program stored in a memory and thereby function as:
an obtaining unit configured to obtain information indicating a current maximum display brightness of the display device;
a determining unit configured to determine a parameter for correcting at least one of noise and resolution of image data based on the information; and
a generating unit configured to generate display image data for live view display on the display device by correcting obtained image data according to the parameter.

2. The image processing apparatus according to claim 1,
wherein the display device is an external apparatus, and
the obtaining unit obtains the information by communicating with the display device.

3. The image processing apparatus according to claim 1, the one or more processors further function as:
a scene determining unit configured to determine a scene represented by the obtained image data, based on luminance of the image data; and
an adjusting unit configured to adjust the maximum display brightness of the display device according to a scene determined by the scene determining unit,
wherein the obtaining unit obtains information indicating maximum display brightness adjusted by the adjusting unit.

4. The image processing apparatus according to claim 1, wherein the parameter is a parameter for correcting at least one of the noise and resolution, in an ICtCp color space.

5. The image processing apparatus according to claim 1, wherein the parameter is a parameter for suppressing change in noise and resolution perceived in display image data displayed in the display device due to change in image capture sensitivity and the maximum display brightness of the image data.

6. An image processing method for generating display image data for live view display on a display device, the image processing method comprising:
obtaining information indicating current maximum display brightness of the display device;
determining a parameter for correcting at least one of noise and resolution of image data based on the information; and
generating display image data for live view display on the display device by correcting obtained image data according to the parameter.

7. A non-transitory computer-readable medium storing a program that, when executed by a computer, causes the computer to perform an image processing method for generating display image data for live view display on a display device, the image processing method comprising:
obtaining information indicating current maximum display brightness of the display device;
determining a parameter for correcting at least one of noise and resolution of image data based on the information; and
generating display image data for live view display on the display device by correcting obtained image data according to the parameter.
